(19) United States
(12) Patent Application Publication
(10) Pub. No.: US 2004/0238428 A1
(43) Pub. Date: Dec. 2, 2004

(54) Wet sump filter adapter

(76) Inventor: Karl Fritze, Denmark Township, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/842,245

(22) Filed: May 10, 2004

Related U.S. Application Data
(60) Provisional application No. 60/469,156, filed on May 9, 2003.

(51) Int. Cl. B01D 27/00

(52) U.S. Cl. 210/234; 210/418

(57) ABSTRACT

An adapter assembly for adapting a wet sump filter manifold to accept quick-dry change cartridge filters. The adapter can be attached to the manifold such that spent cartridge filters can be quickly exchanged for new cartridge filters without spilling water or exposing a user to unclean materials such as scale, biofilm and other contaminants. Once the adapter is attached to the manifold, the adapter can remain continuously attached as cartridge filters are exchanged. The adapter can be designed to appropriately actuate any valves that may exist in the filter manifold and may further including additional valves that act independently or in conjunction with the cartridge filter. The adapter sealing engages both the filter manifold and the cartridge filter to isolate incoming unfiltered water from outgoing filtered water.

### CROSS REFERENCE TO RELATED APPLICATIONS

The present application claims prior to U.S. Provisional Application Ser. No. 60/469,156 entitled, “WET SUMP FILTER ADAPTER”, filed May 9, 2003 and hereby incorporated by reference in its entirety.

### FIELD OF THE INVENTION

The present invention relates to an adapter for adapting an enclosed filter cartridge to a wet sump filter manifold. More particularly, the present invention relates to an adapter to allow the use of quick, dry-change cartridge filters with wet sump filter manifolds.

### BACKGROUND OF THE INVENTION

The popularity of using filtering systems to treat domestic water sources has grown steadily in recent years. In the past, most of the effort has been focused on filtering drinking water at points of use as opposed to filtering the entire domestic water supply. However, many people have begun to recognize the benefits of filtering all domestic water at the house inlet. These benefits include extending the life of household appliances that use water as well as removing particulate matter such as rust and sediment.

One of the most prevalant domestic water filter designs is the wet sump filter assembly. Typically, the wet sump filter assembly consists of an inline manifold, a housing and a filter. The inline manifold includes an inlet port and outlet port, both sized to accommodate typical domestic water consumption. The filter resides within the housing. The housing and manifold are sealably interconnected such that separate and distinct fluid channels are created so as to eliminate fluid communication between the inlet port and outlet port absent the water passing through the filter.

While the wet sump filter assembly successfully removes contaminants from the domestic water flow, it has drawbacks associated with its design. The filter element is a separate component that requires replacement as its filter capacity diminishes. In order to replace a used filter element, a user shuts off the domestic water flow with valves both before and after the manifold. Once the manifold is isolated, the user unscrews the housing from the manifold to access the filter element. When the housing is fully removed, the filter element can be removed and a new element installed. However, this replacement tends to be a wet, messy and potentially toxic experience for the user as water retained in the filter and housing as well as the filtered materials present on the used filter, such as particulate matter, biofilm, iron, etc., are easily spilled on both the user and the floor.

### SUMMARY OF THE INVENTION

The adapter of the present invention is mateable with a wet sump filter manifold and thereafter, effectively, may become a fixed attachment of the wet sump filter manifold. The adapter can be further mateable with a fully encapsulated filter cartridge such that, for all intents and purposes, once the adapter is mated to the filtration manifold, the filtration manifold can accept encapsulated filtration cartridges of a selected design when filter replacement is desired.

The adapter can be designed to appropriately actuate any valves that may exist in the filtration manifold and additionally may include a valve or valves of its own. The adapter can be further mated in sealing engagement with the manifold, acting to prevent intermingling of incoming unfiltered water and outgoing filtered water. The adapter can be further in sealing engagement with the filtration cartridge, again acting to isolate the incoming unfiltered water from the outgoing filtered water.

The adapter may be disengageable from the filtration manifold. In some embodiments the adapter is designed to be engaged with the filtration manifold and remain in such disposition for substantial lengths of time. Specifically, in some embodiments, the filter may be significantly more easily removable from the adapter than the adapter is removable from the filtration manifold. However, the adapter generally is easily connected to the manifold. Once in place, the adapter effectively modifies the filtration manifold such that for the end user, the filtration manifold becomes a manifold that is designed to accept a dry change filtration cartridge. With a dry change filter cartridge, the filtration media is enclosed and sealed within the filter cartridge such that the entire cartridge is replaced rather than just the filtration media itself within the filtration cartridge.

In one aspect, the present invention pertains to a filter adapter for adapting a wet-sump filter manifold to accommodate an enclosed cartridge filter. The adapter comprises an adapter body having a manifold end and a cartridge end. Generally, the manifold end comprises a perimeter wall around a manifold end inlet and a manifold end outlet. The perimeter wall has a manifold end connector for coupling to the manifold, and the cartridge end has a cartridge end outlet, a cartridge end inlet and a cartridge end connector for coupling to the cartridge filter. An unfiltered water channel is defined between the manifold end inlet and the cartridge end outlet and a filtered water channel adapter outlet channel is defined by the cartridge end inlet and the manifold end outlet.

In a further aspect, the invention pertains to a filter adapter for adapting a wet-sump filter manifold to accommodate an enclosed cartridge filter. The adapter comprises an adapter body having a manifold end and a cartridge end. Generally, the manifold end comprises a manifold connector, a manifold end inlet and a manifold end outlet. The manifold end outlet is positioned approximately at the center of the manifold end as viewed along the manifold end inlet. The cartridge end has a cartridge end outlet, a cartridge end inlet and a cartridge end connector for coupling to the cartridge filter. An unfiltered water channel is defined between the manifold end inlet and the cartridge end outlet, and a filtered water channel adapter outlet channel is defined by the cartridge end inlet and the manifold end outlet.

In another aspect, the invention pertains to a water filter assembly comprising a filter manifold and a filter adapter, as described herein. The filter manifold has a manifold inlet channel, a manifold outlet channel and a manifold connector. An unfiltered water circuit is defined by the manifold inlet channel, the adapter inlet channel and the filter inlet channel, and a filtered water circuit is defined by the filter outlet channel, the adapter outlet channel and the manifold outlet channel.

Furthermore, the invention pertains to a method for converting a wet sump filter assembly to a quick-dry change filter assembly, the method comprising attaching an adapter to a filter manifold. The adapter sealingly engages with the filter manifold to define an unfiltered water inlet and a filtered water outlet wherein the filter manifold is configured for connection to a filter canister with an exposed filter element.

### BRIEF DESCRIPTION OF THE DRAWINGS

FIG. 1 is a schematic flow diagram of the flow relationship of some components of a wet sump filter system;

FIG. 2 is a perspective view of a water filter assembly including an adapter as described herein;

FIG. 3 is a side view of the water filter assembly of FIG. 2;

FIG. 4 is a side view of the water filter assembly of FIG. 2 rotated 90° from the view of FIG. 3;

FIG. 5 is an exploded, perspective view of a manifold and an adapter of the present invention;

FIG. 6 is a side view of an adapted manifold of the present invention;

FIG. 7 is a side view of the adapter of the present invention;

FIG. 8 is a perspective view of a manifold end of the adapter of FIG. 7;

FIG. 9 is an end view of the manifold end of FIG. 8;

FIG. 10 is a perspective view of a filter end of the adapter of FIG. 7;

FIG. 11 is an end view of the filter end of FIG. 10; and

FIG. 12 is a sectional view of the adapted manifold taken along line 12-12 of FIG. 6.

### DETAILED DESCRIPTION OF THE DRAWINGS

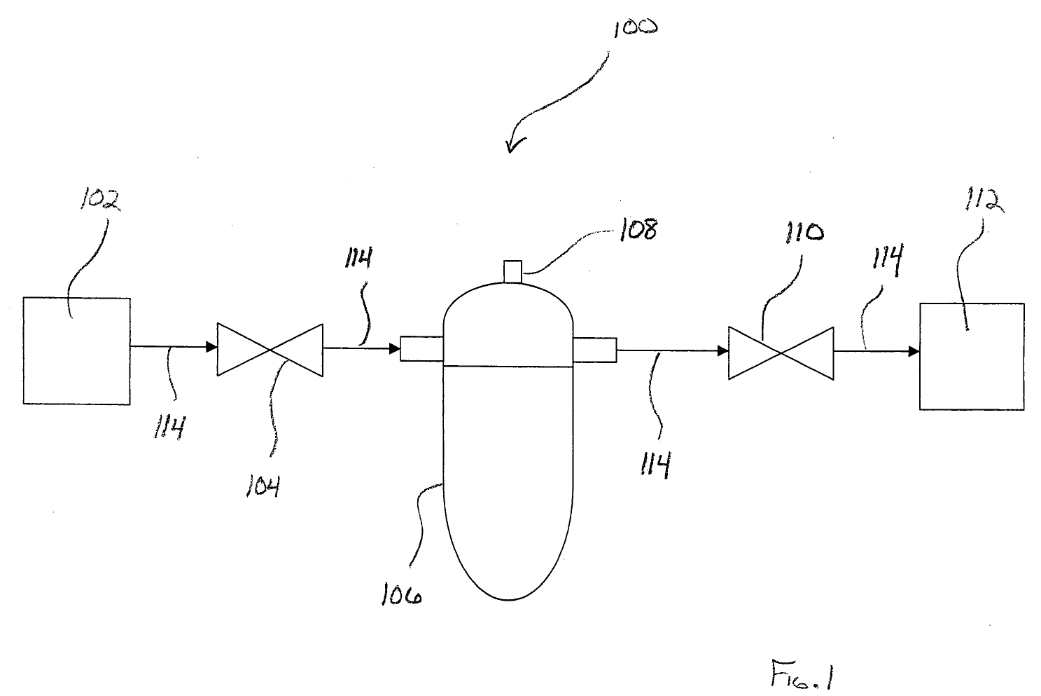

FIG. 1 depicts an embodiment of an installation configuration for a wet sump filter system 100. Filter system 100 comprises an unfiltered water source 102, an upstream isolation valve 104, a filter assembly 106, a manifold vent 108, a downstream isolation valve 110 and points of use 112. Connecting the system components are appropriate lengths of piping 114. Generally, filter assembly 106 is configured for a wet sump filter. With an adapter as described herein, this filter assembly is connected to a quick-dry change filter to become a dry-change filter assembly.

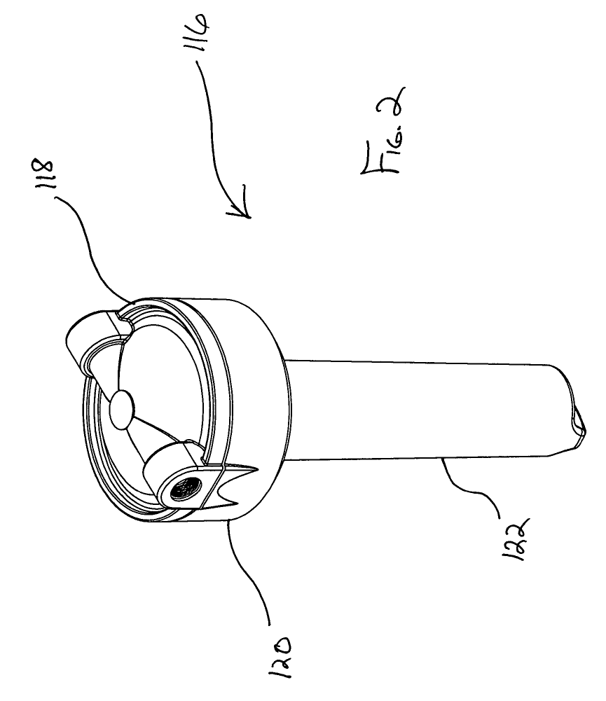

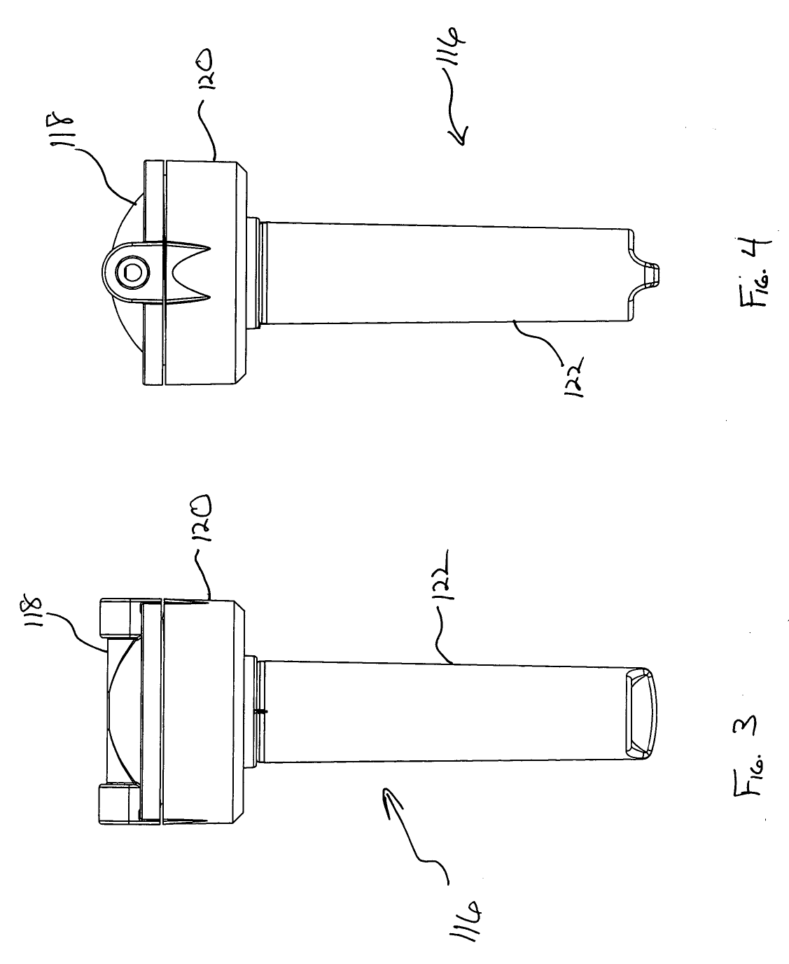

Depicted in FIGS. 2, 3 and 4 is an embodiment of a quick-dry change filter assembly 116. Quick-dry change filter assembly 116 includes a wet sump manifold 118, a wet sump adapter 120 and a quick-dry change filter cartridge 122. Quick-dry change filter cartridge 122 encloses a filter media (not shown). This filter element can comprise of any suitable filtering media including but not limited to pleated filter media, activated carbon filter media, crossflow membrane filter media, fibrous web media, ion exchange media and combinations thereof. Examples of quick-dry change filter cartridge 122 are described in U.S. patent application Ser. Nos. 09/918,316 and 10/202,290, both of which are hereby incorporated by reference in their entirety. Wet sump adapter 120 may comprise the same material of construction as wet sump manifold 118, although other suitable materials or combination of materials can be used. Suitable materials include plastic polymers such as acrylonitrile butadiene styrene, polypropylene, polyethylene, nylon, noryl, combinations thereof or other suitable polymers. Wet sump adapter 120 can be manufactured using an appropriate manufacturing process, for example injection molding.

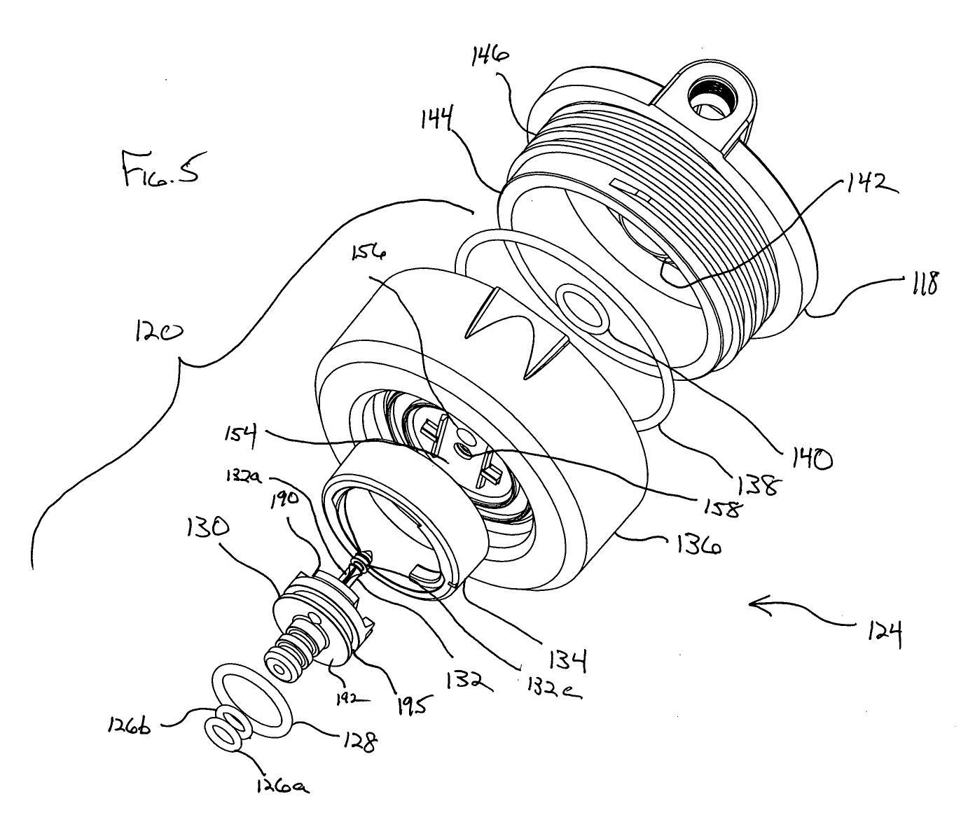

An adapted manifold 124 is depicted in FIGS. 5 and 6. Adapted manifold 124 comprises the combination of wet sump manifold 118 and wet sump adapter 120. In this embodiment, wet sump adapter 120 can comprise, for example, a pair of filtered water seals 126a, 126b, a filter cap interface seal 128, a filter interface 130, a feed valve assembly 132, a filter connector 134, an adapter body 136, a manifold perimeter seal 138, and a manifold filtered water seal 140. In this embodiment, wet sump manifold 118 comprises a manifold projection 142 and a manifold wall 144 having a manifold thread 146. In one embodiment, feed valve assembly 132 can comprise a valve body 132a, a valve spring 132b and a valve seal 132c.

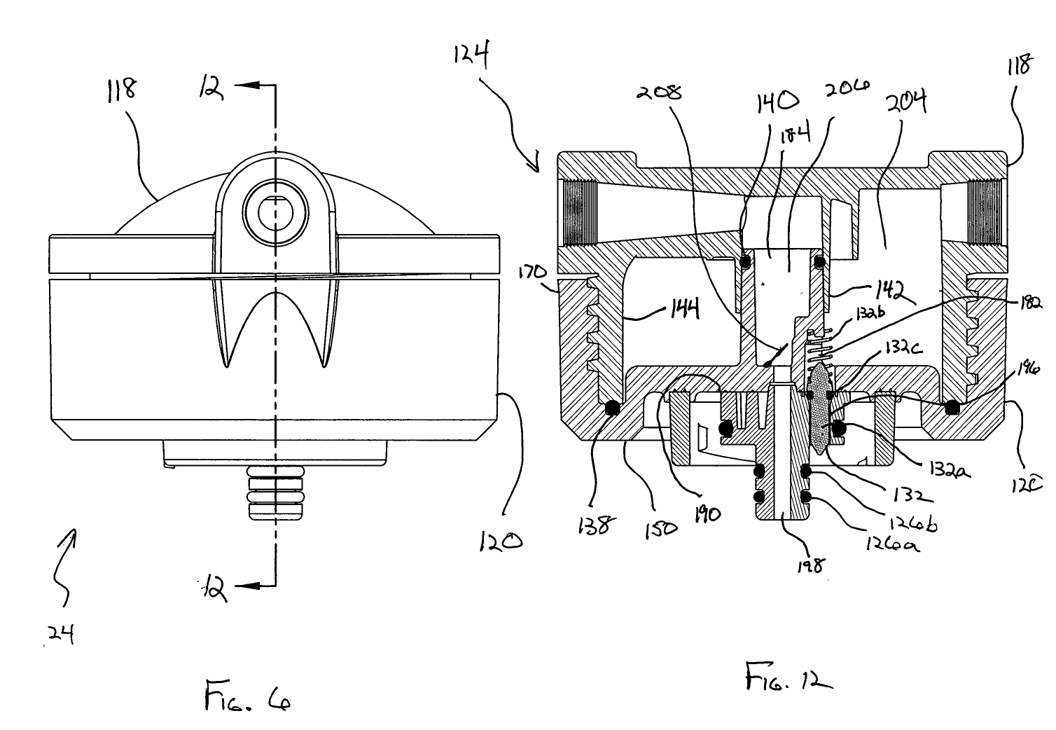

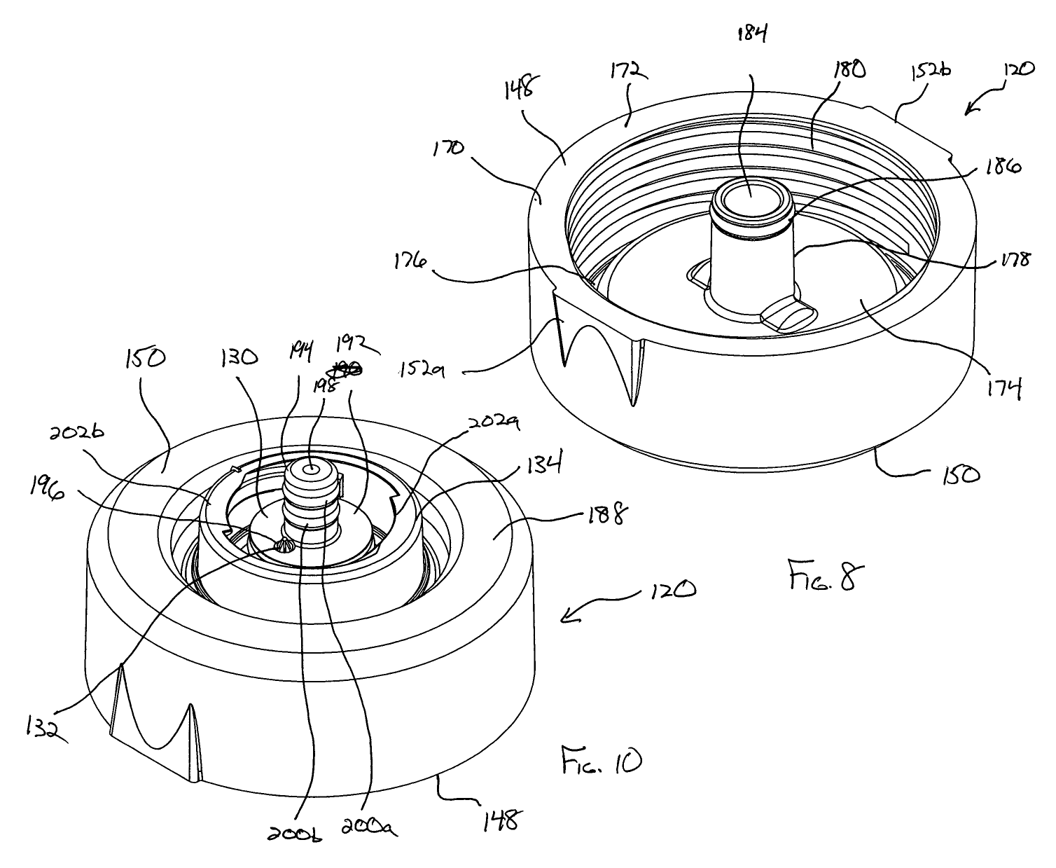

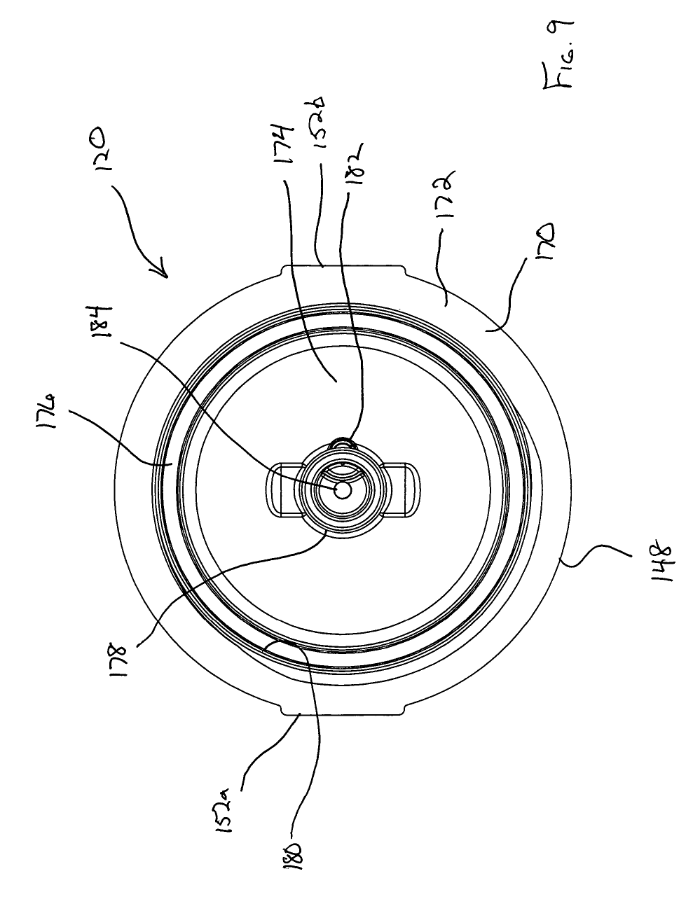

Wet sump adapter 120 is more fully depicted in FIGS. 5, 7, 8, 9, 10 and 11. Wet sump adapter 120 comprises a manifold end 148 and a filter end 150. Adapter body 136 can comprise a pair of alignment tabs 152a, 152b. At the filter end 150, adapter body 136 further comprises a distribution surface 154 with a body inlet bore 156 and body outlet bore 158.

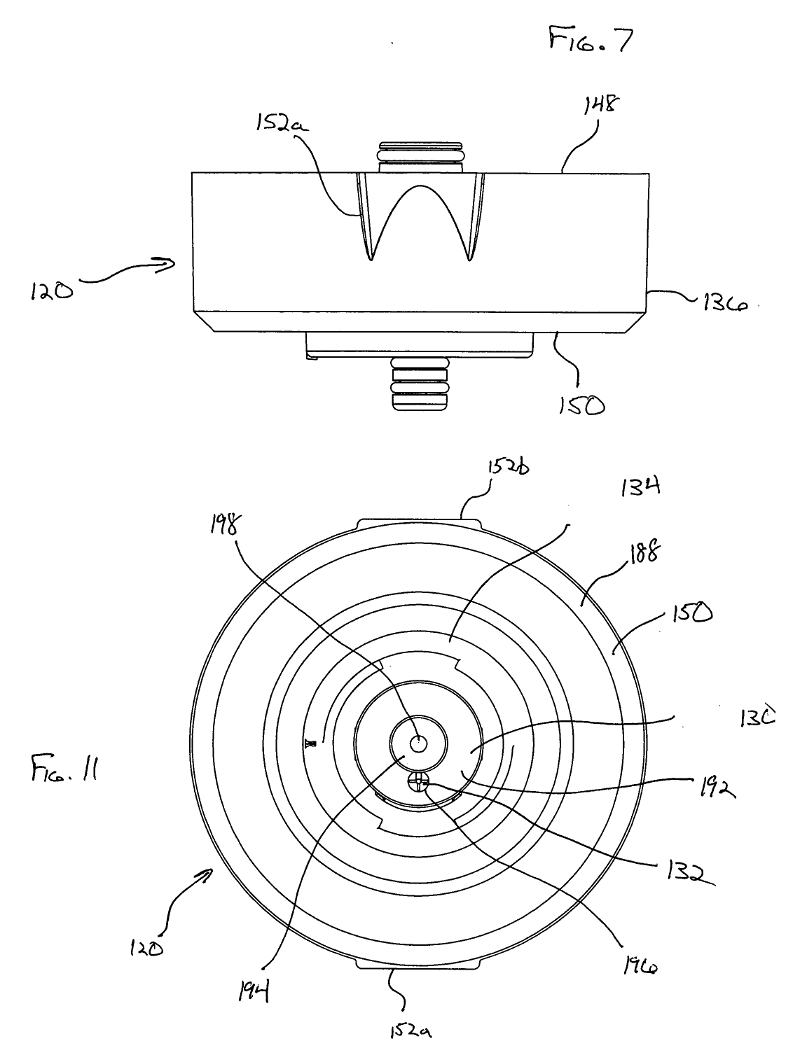

As illustrated in FIGS. 8 and 9, manifold end 148 has a perimeter wall 170, a wall face 172, a floor 174, a circumferential floor groove 176 and a manifold projection 178. Perimeter wall 170 has an internal thread 180. Floor 174 includes a manifold end feed bore 182. Manifold projection 178 includes a manifold end outlet bore 184 and a projection groove 186. Manifold end feed bore 182 is fluidly connected to body inlet bore 156 while the manifold end outlet bore 184 is fluidly connected to the body outlet bore 158.

As illustrated in FIGS. 5, 10 and 11, filter end 150 has a circumferential wall 188, the filter interface 130 and the filter connector 134. The filter interface 130 has an attachment surface 190, an interface surface 192, a filter projection 194 and a perimeter groove 195. Interface surface 192 comprises a filter end feed bore 196. Filter projection 194 comprises a filter end outlet bore 198 and a pair of projection grooves 200a, 200b. Filter connector 134 comprises a pair of attachment members 202a, 202b. Attachment members 202a, 202b can comprise suitable attachment designs, for example, ramp and tab assemblies or helical thread assemblies, such as described in copending U.S. patent application Ser. Nos. 09/618,686, 10/196,340, and 10/406,637, all of which are incorporated by reference in their entirety.

As illustrated in FIGS. 5 and 12, wet sump adapter 120 can be assembled by attaching the filter connector 134 and the filter interface 130 to the adapter body 136. Attachment can be accomplished, for example by the use of adhesives, sonic welding, thermal processes or a combination thereof, although at least filter connector 134 and adapter body 136, alternatively, can be molded as an integral assembly. Prior to attaching filter interface 130 to the adapter body 136, the feed valve assembly 132 is captured within the body inlet bore 156 The filter cap interface seal 128 can be placed over the perimeter groove 195 while the filtered water seals 126a, 126b are placed over the projection grooves 202a, 202b. On the manifold end 148, the manifold perimeter seal 138 is placed within the floor groove 176 while the manifold filtered water seal 140 is positioned over the projection groove 186.

As shown in FIG. 12, wet sump adapter 120 defines a continuous inlet water channel 204 comprising the manifold end feed bore 182, the body inlet bore 156, and the filter end feedbore 196. The feed valve assembly 132 is operably located within the continuous inlet water channel 204. In the unbiased disposition depicted in FIG. 12, valve body 132a and especially valve seal 132c sealingly engage the filter interface 130 at attachment surface 190 to prevent water flow through the continuous inlet water channel 204. A continuous outlet water channel 206 comprises the filter end outlet bore 198, the body outlet bore 158 and the manifold end outlet bore 184. In another embodiment, continuous outlet water channel 206 can include a check valve 208, for example a hinged valve as shown in FIG. 12 or a ball check, to prevent backward flow of water through the wet sump adapter 120.

In general, the adapted manifold 124 can be assembled by engaging the wet sump adapter 120 with the wet sump manifold 118. Generally, wet sump adapter 120 is positioned so that manifold end 148 is in proximity to the wet sump manifold 118. In this embodiment, the wet sump adapter 120 is rotatably attached to the wet sump manifold by rotatably engaging the manifold thread 146 with the internal thread 180. As wet sump adapter 120 is rotatably attached to the wet sump manifold 118, the manifold wall 144 sealingly engages the manifold perimeter seal 138 while the adapter manifold projection 178 sealingly inserts into the manifold projection 142 with the manifold filtered water seal 140 engaging the inside of the manifold projection 142. Alignment tabs 152a, 152b can be used to align with features on the wet sump manifold 118 to indicate when the wet sump adapter 120 is properly engaged with the wet sump manifold 118. Manifold thread 146 and internal thread 180 can provide for multiple points of contact and the manifold filtered water seal 140 can be dimensioned to tightly seal and engage against the interior of manifold projection 142 to increase the frictional engagement of the wet sump adapter 120 and the wet sump manifold 118 such that once attached, the wet sump adapter 120 remains fixedly attached to the wet sump manifold 118.

Similarly, a user can attach quick-dry change filter cartridge 122 to wet sump adapter 120. Generally, a user positions a filter cap (not shown) in proximity to filter end 150. The filter cap inserts into filter connector 134 and rotatably engages attachment members 202a, 202b. Attachment members 202a, 202b and the filter cap can be configured such that rotatable engagement with a quarter turn of quick-dry change filter cartridge 122. The rotation of quick-dry change filter cartridge 122 in relation to the wet sump adapter 120 positions filter projection 144 into a central bore (not shown) on the filter cap of quick-dry change filter cartridge 122. Filter water seals 126a, 126b sealingly engage the interior wall of the central bore on the filter cap while the filter cap interface seal 128 isolates feed bores in the filter cap from the central bore. When the quick-dry change cartridge filter 122 is attached to wet sump adapter 120, an engagement mechanism, for example an arcuate ramp, on the filter cap actuates the feed valve assembly 132 to allow water flow through the continuous inlet water channel 204. As the quick-dry change filter cartridge 122 encapsulates its filter element, the user is not exposed to the filtered contaminants when replacing a used quick-dry change filter cartridge 122. Generally, the engagement of quick-dry change cartridge filter 122 with wet sump adapter 120 requires less frictional engagement than the engagement of the wet sump adapter 120 and the wet sump manifold 118 such that removal of the quick-dry change cartridge filter 122 can be accomplished without removing the wet sump adapter 120 from the wet sump manifold 118.

Once wet sump adapter 120 has been connected to wet sump manifold 118 and quick-dry change filter cartridge 122, the domestic water quick-dry change filter assembly 116 is ready for use. Generally, inlet water flows into an inlet on wet sump manifold 118 where it is directed to the quick-dry change cartridge filter 122 through the continuous inlet water channel 204. The inlet water flows through the media contained within the quick-dry change cartridge filter 122 and is distributed to points of use through the continuous outlet water channel 206.

Although various embodiments of the present invention have been disclosed here for purposes of illustration, it should be understood that a variety of changes, modifications and substitutions might be incorporated without departing from either the spirit or scope of the present invention.

1. A filter adapter for adapting a wet-sump filter manifold to accommodate an enclosed cartridge filter, the adapter comprising:
an adapter body having a manifold end and a cartridge end wherein the manifold end comprises a perimeter wall around a manifold end inlet and a manifold end outlet, the perimeter wall having a manifold end connector for coupling to the manifold and wherein the cartridge end has a cartridge end outlet, a cartridge end inlet and a cartridge end connector for coupling to the cartridge filter, wherein an unfiltered water channel is defined between the manifold end inlet and the cartridge end outlet and a filtered water channel adapter outlet channel is defined by the cartridge end inlet and the manifold end outlet.

2. The filter adapter of claim 1 wherein the perimeter wall comprises inner threads.

3. The water filter adapter of claim 1 wherein the adapter body comprises a biased closed valve mounted within the unfiltered water channel wherein the biased closed valve is actuatable by the cartridge filter.

4. The water filter adapter of claim 1 wherein the adapter body includes a check valve mounted within the filtered water channel to prevent backward flow through the filtered water channel.

5. The water filter adapter of claim 1 wherein the manifold end outlet comprises a projection having an exterior manifold outlet seal adapted to sealingly engage the manifold.

6. The water filter adapter of claim 5 wherein the manifold outlet seal comprises an o-ring seal.

7. The water filter adapter of claim 1 wherein the cartridge end outlet comprises a projection having an exterior cartridge outlet seal adapted to sealingly engage the cartridge filter.

8. The water filter adapter of claim 7 wherein the cartridge outlet seal comprises an o-ring seal.

9. The water filter adapter of claim 1 wherein the manifold end connector is adapted to rotatably interconnect with the filter manifold.

10. The water filter adapter of claim 1 wherein the cartridge end connector is adapted to rotatably interconnect with the cartridge filter.

11. The water filter adapter of claim 1 wherein the manifold end connector is configured to remain attached to the manifold when the cartridge filter is detached from the cartridge end connector.

12. A water filter assembly comprising:
a filter manifold having a manifold inlet channel, a manifold outlet channel and a manifold connector; and
a filter adapter of claim 1,
wherein an unfiltered water circuit is defined by the manifold inlet channel, the adapter inlet channel and the filter inlet channel and wherein a filtered water circuit is defined by the filter outlet channel, the adapter outlet channel and the manifold outlet channel.

13. The water filter assembly of claim 12 further comprising a cartridge filter having a cartridge housing enclosing a filter media, the cartridge housing comprising a cartridge head with a filter connector for connecting to the dry change connector and wherein the cartridge head defines a filter inlet channel and a filter outlet channel.

14. The water filter assembly of claim 13 the filter media comprising granular activated carbon media, melt blown fiber media and perforated filter sheet media.

15. The water filter assembly of claim 13 wherein the unfiltered water circuit and the filtered water circuit are isolated by at least one manifold seal and at least one filter seal.

16. The water filter assembly of claim 15 wherein the at least one manifold seal and the at least one filter seal comprise an o-ring seal.

17. A filter adapter for adapting a wet-sump filter manifold to accommodate an enclosed cartridge filter, the adapter comprising:
an adapter body having a manifold end and a cartridge end wherein the manifold end comprises a manifold connector, a manifold end inlet and a manifold end outlet wherein the manifold end outlet is positioned approximately at the center of the manifold end as viewed along the manifold end inlet, and wherein the cartridge end has a cartridge end outlet, a cartridge end inlet and a cartridge end connector for coupling to the cartridge filter, wherein an unfiltered water channel is defined between the manifold end inlet and the cartridge end outlet and a filtered water channel adapter outlet channel is defined by the cartridge end inlet and the manifold end outlet.

18. The filter adapter of claim 17 wherein the manifold end comprises a manifold projection with a central channel leading to the manifold end outlet.

19. The filter adapter of claim 17 wherein the manifold end comprises a perimeter wall with internal threads.

20. The water filter adapter of claim 17 wherein the adapter body comprises a biased closed valve mounted within the unfiltered water channel wherein the biased closed valve is actuatable by the cartridge filter.

21. A water filter assembly comprising:
a filter manifold having a manifold inlet channel, a manifold outlet channel and a manifold connector; and
a filter adapter of claim 17,
wherein an unfiltered water circuit is defined by the manifold inlet channel, the adapter inlet channel and the filter inlet channel and wherein a filtered water circuit is defined by the filter outlet channel, the adapter outlet channel and the manifold outlet channel.

22. A method for converting a wet sump filter assembly to a quick-dry change filter assembly, the method comprising:
attaching an adapter to a filter manifold, the adapter sealingly engaging with the filter manifold to define an unfiltered water inlet and a filtered water outlet wherein the filter manifold is configured for connection to a filter canister with an exposed filter element.

23. The method of claim 22 further comprising attaching a cartridge filter to the adapter to define an uninterrupted unfiltered water channel and an uninterrupted filtered water channel.

24. The method of claim 23 further comprising removing the cartridge filter after use from the adapter such that the adapter remains attached to the filter manifold and attaching a new cartridge filter to the adapter.

25. The method of claim 22 wherein the adapter is rotatably attached to the filter manifold.

26. The method of claim 22 wherein the cartridge filter is rotatably attached to the manifold.

27. The method of claim 22 wherein the adapter comprises a manifold end and a cartridge end wherein the manifold end comprises a perimeter wall around a manifold end inlet and a manifold end outlet, the perimeter wall having a manifold end connector for coupling to the manifold.

28. The method of claim 22 wherein the adapted comprises a manifold end and a cartridge end wherein the manifold end comprises a manifold connector, a manifold end inlet and a manifold end outlet wherein the manifold end outlet is positioned approximately at the center of the manifold end as viewed along the manifold end inlet.
